(19) United States
(12) Patent Application Publication
(10) Pub. No.: US 2025/0214588 A1
(43) Pub. Date: Jul. 3, 2025

(54) LANE CHANGE ASSISTANCE DEVICE

(71) Applicant: HONDA MOTOR CO., LTD, Tokyo (JP)

(72) Inventor: Haruhiko NISHIGUCHI, Saitama (JP)

(73) Assignee: HONDA MOTOR CO., LTD, Tokyo (JP)

(21) Appl. No.: 18/852,499

(22) PCT Filed: Mar. 30, 2022
(86) PCT No.: PCT/JP2022/016350

§ 371 Date: Sep. 30, 2024

(51) Int. Cl. B60W 30/18; B60W 30/16; B60W 50/14

(52) U.S. Cl. CPC B60W 30/18163; B60W 30/16; B60W 50/14; B60W 2540/20; B60W 2552/10; B60W 2554/4041; B60W 2554/802; B60W 2554/804; B60W 2720/10; B60W 2720/106

(57) ABSTRACT

A lane change assistance device includes: a recognition unit configured to recognize a surrounding situation of a host vehicle; a lane change determination unit configured to determine, when another vehicle traveling in an adjacent lane is detected, whether a lane change is possible based on a relative speed between the host vehicle and the another vehicle and an inter-vehicle distance therebetween; and a travel control unit configured to execute the lane change based on a determination result. The travel control unit is configured to further execute travel speed control for controlling a travel speed of the host vehicle based on a target speed set in advance. The lane change determination unit is configured to determine, while the travel speed control is being executed, whether the lane change is possible based on the relative speed when the target speed is the travel speed of the host vehicle.

### TECHNICAL FIELD

The present invention relates to a lane change assistance device.

### BACKGROUND ART

In recent years, active efforts have been made to provide access to a sustainable transportation system in consideration of vulnerable traffic participants. As one of these efforts, research and development on driving assist techniques and automated driving techniques for vehicles such as automobiles have been made in order to further improve safety and convenience of traffic. As an example of the driving assist techniques, Patent Literature 1 listed below discloses a lane change assistance device that causes a host vehicle to execute a lane change from a host lane to an adjacent lane.

### CITATION LIST

### Patent Literature

Patent Literature 1: JP2017-074823A

### SUMMARY OF INVENTION

### Technical Problem

In an existing lane change assistance device, it is determined whether a lane change is possible based on a relative speed of a host vehicle with respect to another vehicle which is in accordance with a current travel speed of the host vehicle. Therefore, for example, when the host vehicle travels at a low speed due to an influence of a preceding vehicle or the like, it may be difficult to execute the lane change.

The present invention provides a lane change assistance device capable of increasing an opportunity to execute a lane change.

### Solution to Problem

One aspect of the present invention is a lane change assistance device capable of executing a lane change of a host vehicle from a host lane on which the host vehicle travels to an adjacent lane adjacent to the host lane, the lane change assistance device including:
a recognition unit configured to recognize a surrounding situation of the host vehicle;
a lane change determination unit configured to determine, when another vehicle traveling in the adjacent lane is detected by the recognition unit, whether the lane change is possible based on a relative speed between the host vehicle and the another vehicle and an inter-vehicle distance between the host vehicle and the another vehicle; and
a travel control unit configured to execute the lane change based on a determination result of the lane change determination unit, in which
the travel control unit is configured to further execute travel speed control for controlling a travel speed of the host vehicle based on a target speed set in advance, and
the lane change determination unit is configured to determine, while the travel speed control is being executed, whether the lane change is possible based on the relative speed when the target speed is the travel speed of the host vehicle.

### Advantageous Effects of Invention

According to the present invention, it is possible to provide a lane change assistance device capable of increasing an opportunity to execute a lane change.

### BRIEF DESCRIPTION OF DRAWINGS

FIG. 1 is a block diagram showing an overall configuration of a vehicle system 1 on which a control device 100 according to an embodiment is mounted;

FIG. 2 is a diagram showing an example of a configuration of a first control unit 120 and a second control unit 160;

FIG. 3 is a diagram showing an example of a steering wheel 82 and a blinker lever 81;

FIG. 4 is a diagram showing a specific example of an operation of the blinker lever 81;

FIG. 5 is a diagram showing an example of a lane change operation of a host vehicle M by the control device 100 during execution of ACC;

FIG. 6 is a diagram showing an example of a minimum inter-vehicle distance at which a lane change can be executed for each relative speed;

FIG. 7 is a diagram showing an example of a minimum inter-vehicle distance d1 at which the lane change is executable when a relative speed between the host vehicle M and a following vehicle M2 is AV1 and a minimum inter-vehicle distance d2 at which the lane change is executable when the relative speed between the host vehicle M and the following vehicle M2 is AV2;

FIG. 8 is a flowchart (part 1) showing an example of lane change assistance processing executed by the control device 100;

FIG. 9 is a flowchart (part 2) showing the example of the lane change assistance processing executed by the control device 100;

FIG. 10 is a flowchart (part 1) showing an example of lane change possibility determination processing executed by the control device 100;

FIG. 11 is a flowchart (part 2) showing the example of the lane change possibility determination processing executed by the control device 100; and

FIG. 12 is a flowchart showing an example of lane change stop determination processing executed by the control device 100.

### DESCRIPTION OF EMBODIMENTS

Hereinafter, an embodiment of a lane change assistance device according to the present invention will be described with reference to the drawings. Hereinafter, the same or similar elements are denoted by the same or similar reference signs, and a description thereof may be appropriately omitted or simplified.

### <Overall Configuration of Vehicle System 1>

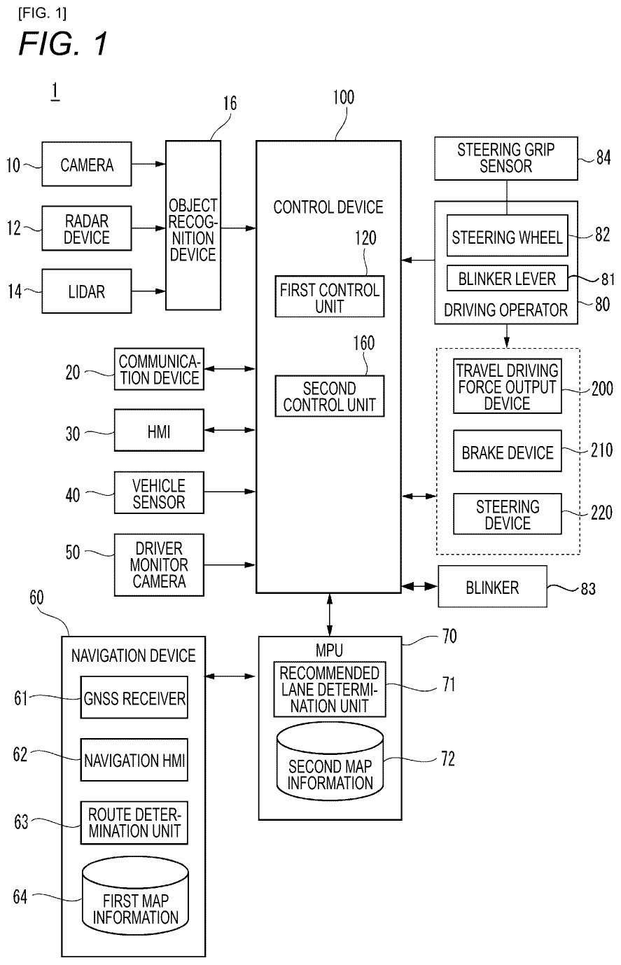

FIG. 1 is a block diagram showing an overall configuration of a vehicle system 1 on which a control device 100 that is an embodiment of a lane change assistance device according to the present invention is mounted. A vehicle on which the vehicle system 1 is mounted (hereinafter, referred to as a “host vehicle M”) is, for example, a vehicle such as a two-wheeled vehicle, a three-wheeled vehicle, or a four-wheeled vehicle, and a drive source thereof is an internal combustion engine such as a diesel engine or a gasoline engine; an electric motor; or a combination thereof. The electric motor operates using electric power generated by an electric generator connected to the internal combustion engine or electric power discharged from a secondary battery or a fuel cell.

The vehicle system 1 includes, for example, a camera 10, a radar device 12, a light detection and ranging (LIDAR) 14, an object recognition device 16, a communication device 20, a human machine interface (HMI) 30, a vehicle sensor 40, a driver monitor camera 50, a navigation device 60, a map positioning unit (MPU) 70, a driving operator 80, a blinker 83, the control device 100, a travel driving force output device 200, a brake device 210, and a steering device 220. These devices and equipment are connected to each other via, for example, a multiplex communication line such as a controller area network (CAN) communication line, a serial communication line, or a wireless communication network.

The camera 10 is, for example, a digital camera using a solid-state imaging device such as a charge coupled device (CCD) or a complementary metal oxide semiconductor (CMOS). The camera 10 is attached to any portion of the host vehicle M on which the vehicle system 1 is mounted.

The radar device 12 emits radio waves such as millimeter waves to surroundings of the host vehicle M, and detects radio waves (reflected waves) reflected by an object to detect at least a position (distance and orientation) of the object. The radar device 12 is attached to any portion of the host vehicle M.

The LIDAR 14 emits light (or an electromagnetic wave having a wavelength close to that of light) to the surroundings of the host vehicle M and measures scattered light. The LIDAR 14 detects a distance to a target based on a time elapsed from light emission to light reception. The emitted light is, for example, pulsed laser light. The LIDAR 14 is attached to any portion of the host vehicle M.

The object recognition device 16 executes sensor fusion processing on some or all of detection results of the camera 10, the radar device 12, and the LIDAR 14 to recognize a position, a type, a speed, and the like of an object. The object recognition device 16 outputs a recognition result to the control device 100. The object recognition device 16 may output the detection results of the camera 10, the radar device 12, and the LIDAR 14 to the control device 100 as they are.

The communication device 20 uses, for example, a cellular network, a Wi-Fi (registered trademark) network, Bluetooth (registered trademark), or dedicated short range communication (DSRC) to communicate with other vehicles present in the surroundings of the host vehicle M or communicate with various server devices via a radio base station. The HMI 30 presents various information to an occupant of the host vehicle M and

receives an input operation performed by the occupant. The HMI 30 includes various display devices, a speaker, a buzzer, a touch panel, a switch, a key, and the like.

The vehicle sensor 40 includes a vehicle speed sensor that detects a travel speed (so-called “vehicle speed”; hereinafter also simply referred to as a “speed”) of the host vehicle M, an acceleration sensor that detects an acceleration, a yaw rate sensor that detects an angular speed around a vertical axis, an azimuth sensor that detects an orientation of the host vehicle M, and the like.

The driver monitor camera 50 is, for example, a digital camera using a solid-state imaging device such as a CCD or a CMOS. The driver monitor camera 50 is attached to any portion of the host vehicle M in a position and an orientation in which an image of a head of an occupant (hereinafter, also referred to as a “driver”) seated in a driver's seat of the host vehicle M can be captured from the front (that is, in an orientation in which an image of a face is captured).

The navigation device 60 includes, for example, a global navigation satellite system (GNSS) receiver 61, a navigation HMI 62, and a route determination unit 63. The navigation device 60 stores first map information 64 in a storage device such as a hard disk drive (HDD) or a flash memory.

The GNSS receiver 61 specifies a position of the host vehicle M based on a signal received from a GNSS satellite. The position of the host vehicle M may be specified or complemented by an inertial navigation system (INS) using an output of the vehicle sensor 40.

The navigation HMI 62 includes a display device, a speaker, a touch panel, a key, and the like. The navigation HMI 62 may be partially or entirely shared with the HMI 30 described above.

For example, with reference to the first map information 64, the route determination unit 63 determines a route (hereinafter, also referred to as an “on-map route”) from the position of the host vehicle M specified by the GNSS receiver 61 (or an input any position) to a destination input by the occupant using the navigation HMI 62. The first map information 64 is, for example, information in which a road shape is expressed by a link indicating a road and nodes connected by the link. The first map information 64 may include a curvature of a road, point of interest (POI) information, and the like. The on-map route is output to the MPU 70.

The navigation device 60 may perform route guidance using the navigation HMI 62 based on the on-map route. The navigation device 60 may transmit a current position and the destination to a navigation server via the communication device 20 and acquire a route equivalent to the on-map route from the navigation server.

The MPU 70 includes, for example, a recommended lane determination unit 71, and stores second map information 72 in a storage device such as an HDD or a flash memory. The recommended lane determination unit 71 divides the on-map route provided by the navigation device 60 into a plurality of blocks (for example, divides the on-map route by 100 [m] in a vehicle traveling direction), and determines a recommended lane for each block with reference to the second map information 72. For example, the recommended lane determination unit 71 determines which lane from the left the vehicle is to travel in. When a branch point is present in the on-map route, the recommended lane determination unit 71 determines a recommended lane such that the host vehicle M may travel along a reasonable route for advancing to a branch destination.

The second map information 72 is map information with higher accuracy than the first map information 64. The second map information 72 includes, for example, information on a center of a lane or information on a boundary of the lane. The second map information 72 may include road information, traffic regulation information, address information, facility information, telephone number information, and the like. The second map information 72 may be updated, as required, by the communication device 20 communicating with another device.

The driving operator 80 includes, for example, an accelerator pedal, a brake pedal, a shift lever, and other operators in addition to a blinker lever 81 and a steering wheel 82. A sensor that detects an operation amount or the presence or absence of an operation is attached to the driving operator 80, and a detection result thereof is output to some or all of the control device 100, the travel driving force output device 200, the brake device 210, and the steering device 220.

The blinker lever 81 is an operator for turning on or off the blinker 83, and also functions as an operator for receiving an operation as a lane change request. As will be described in detail later, the control device 100 detects the lane change request from the driver based on a predetermined operation on the blinker lever 81 performed by the driver.

The blinker 83 is a direction indicator provided on each of a left side (for example, left front and left rear) and a right side (for example, right front and right rear) of the host vehicle M and at a position visible from the outside of the host vehicle M. The control device 100 turns on (including blinking) or off the blinker 83 according to an operation on the blinker lever 81.

The steering wheel 82 is an operator for receiving a steering operation. The steering wheel 82 is not necessarily in an annular shape, and may be in a form of deformed steering, joy stick, a button, or the like. A steering grip sensor 84 is attached to the steering wheel 82. The steering grip sensor 84 is implemented by a static capacitance sensor or the like, and outputs, to the control device 100, a signal capable of detecting whether the driver is gripping the steering wheel 82.

The control device 100 is a computer that integrally controls the entire host vehicle M, and includes, for example, a first control unit 120 and a second control unit 160. Each of the first control unit 120 and the second control unit 160 is implemented by, for example, a hardware processor such as a central processing unit (CPU) executing a program (software). Some or all of these constituent elements may be implemented by hardware (including circuitry) such as a large scale integration (LSI), an application specific integrated circuit (ASIC), a field-programmable gate array (FPGA), and a graphics processing unit (GPU), or may be implemented by cooperation of software and hardware. The program may be stored in advance in a storage device such as an HDD or a flash memory of the control device 100.

### <Configuration of First Control Unit 120 and Second Control Unit 160>

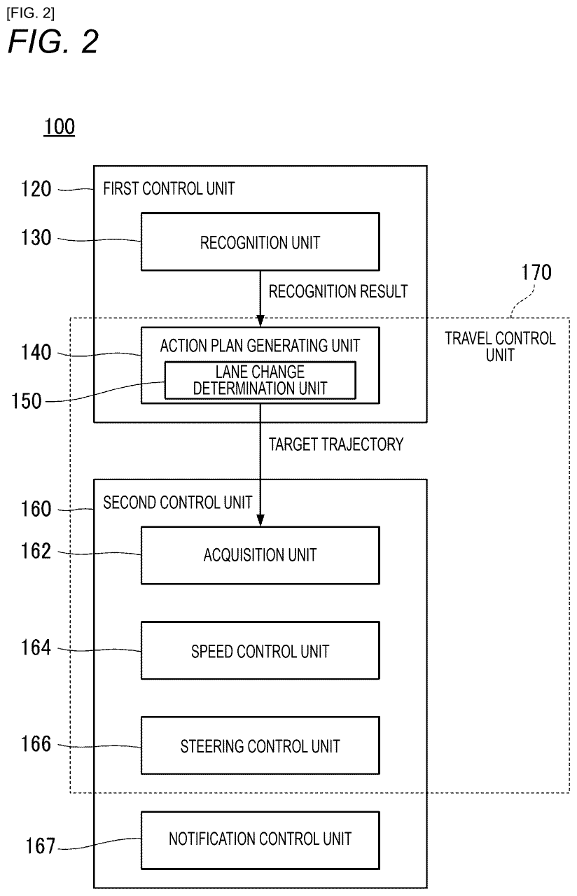

FIG. 2 is a diagram showing an example of a configuration of the first control unit 120 and the second control unit 160. The first control unit 120 includes, for example, a recognition unit 130 and an action plan generating unit 140. The first control unit 120 implements, for example, a function based on artificial intelligence (AI) and a function based on a model given in advance in parallel.

For example, a function of “recognizing a crossing point” may be implemented by performing recognition of a crossing point by deep learning or the like and recognition based on a condition given in advance (signal enabling pattern matching, road marking, or the like) in parallel and performing comprehensive evaluation by scoring the both recognition. Accordingly, reliability of automated driving is ensured.

The recognition unit 130 recognizes a surrounding situation of the host vehicle M based on information input from the camera 10, the radar device 12, and the LIDAR 14 via the object recognition device 16. Specifically, the recognition unit 130 recognizes a position of an object in the surroundings of the host vehicle M, and a traveling state including a speed, an acceleration, and the like of the object. For example, the position of the object is recognized as a position on absolute coordinates with a representative point (center of gravity, drive shaft center, or the like) of the host vehicle M as an origin, and is used for control. The position of the object may be represented by a representative point such as a center of gravity or a corner of the object, or may be represented by a region. A “state” of the object may include an acceleration or jerk of the object, or an “action state” (for example, whether the object is changing a lane, or whether the object is about to change the lane). The object recognized by the recognition unit 130 includes another vehicle (hereinafter, also referred to as a “preceding vehicle”) M1 traveling in front of the host vehicle M and another vehicle (hereinafter, also referred to as a “following vehicle”) M2 traveling behind the host vehicle M.

For example, the recognition unit 130 recognizes a travel environment in which the host vehicle M travels. For example, the recognition unit 130 recognizes a travel lane of the host vehicle M by comparing a pattern of road division lines (for example, an array of solid lines and broken lines) obtained from the second map information 72 with a pattern of road division lines in the surroundings of the host vehicle M recognized from an image captured by the camera 10. The recognition unit 130 may recognize the travel lane by recognizing not only the road division lines but also a course boundary (road boundary) including a road division line, a road shoulder, a curbstone, a median strip, a guard rail, and the like. In the recognition, the position of the host vehicle M acquired from the navigation device 60 or a processing result of the INS may be added. The recognition unit 130 may recognize a temporary stop line, an obstacle, a red signal, a tollgate, and other road events.

When recognizing the travel lane, the recognition unit 130 recognizes a position and a posture of the host vehicle M with respect to the travel lane. For example, the recognition unit 130 may recognize a deviation of a reference point of the host vehicle M from a lane center and an angle of a traveling direction of the host vehicle M with respect to a line connecting the lane center, as a relative position and a posture of the host vehicle M with respect to the travel lane. Alternatively, the recognition unit 130 may recognize a position of the reference point of the host vehicle M with respect to any side end portion (road division line or road boundary) of the travel lane as the relative position of the host vehicle M with respect to the travel lane.

The action plan generating unit 140 generates a target trajectory in which the host vehicle M travels in principle in a recommended lane determined by the recommended lane determination unit 71, and further automatically travels in the future (regardless of an operation of the driver) so as to correspond to the surrounding situation of the host vehicle M. The target trajectory includes, for example, a speed element. For example, the target trajectory is represented by arranging points (trajectory points) to be reached by the host vehicle M in order. The trajectory point is a point to be reached by the host vehicle M for each predetermined travel distance (for example, about several meters) in a road distance, and separately, a target speed and a target acceleration for each predetermined sampling time (for example, about a few fractions of a second) are generated as a part of the target trajectory. The trajectory point may be a position to be reached by the host vehicle M at a sampling time point within each predetermined sampling time. In this case, information on the target speed and the target acceleration is expressed by an interval of the trajectory points.

The action plan generating unit 140 may set an event of automated driving when generating the target trajectory. The event of the automated driving includes a constant speed traveling event, a low speed following traveling event, a lane change event, a branching event, a merging event, a take over event, and the like. The action plan generating unit 140 generates the target trajectory according to an activated event.

As an example, the action plan generating unit 140 includes a lane change determination unit 150 that determines whether a lane change is possible based on the travel environment of the host vehicle M recognized by the recognition unit 130. For example, when another vehicle traveling in an adjacent lane adjacent to the travel lane of the host vehicle Mis detected, the lane change determination unit 150 determines whether the lane change is possible based on a relative speed between the host vehicle M and the another vehicle and an inter-vehicle distance between the host vehicle M and the another vehicle.

Then, the action plan generating unit 140 sets a lane change event or generates a target trajectory according to the lane change event based on the lane change determination unit 150 determining that the lane change is possible. Thus, a travel control unit 170 to be described later is configured to be able to execute the lane change based on the determination result of the lane change determination unit 150. A specific content of the determination of whether the lane change is possible by the control device 100, which is implemented by the lane change determination unit 150 or the like, will be described later, and thus the description thereof will be omitted here.

The second control unit 160 controls the host vehicle M to pass through, at a scheduled time point, the target trajectory generated by the action plan generating unit 140. The second control unit 160 includes, for example, an acquisition unit 162, a speed control unit 164, and a steering control unit 166.

The acquisition unit 162 acquires information on the target trajectory (trajectory points) generated by the action plan generating unit 140 and stores the information in a memory (not shown). The speed control unit 164 controls the travel driving force output device 200 (see FIG. 1) or the brake device 210 (see FIG. 1) based on the speed element accompanying the target trajectory stored in the memory. The steering control unit 166 controls the steering device 220 (see FIG. 1) according to a degree of curvature of the target trajectory stored in the memory. Processing of the speed control unit 164 and the steering control unit 166 is implemented by, for example, a combination of feedforward control and feedback control.

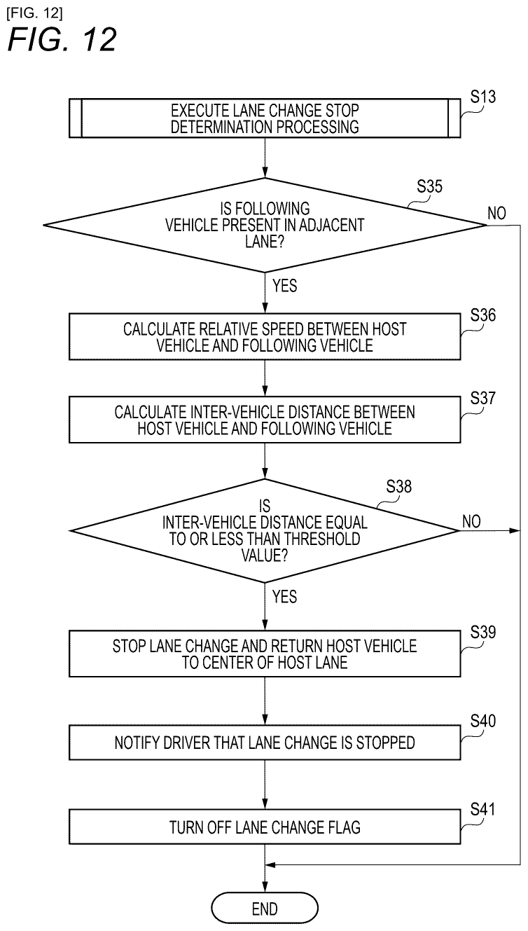

The second control unit 160 further includes, for example, a notification control unit 167. The notification control unit 167 controls the HMI 30, the navigation HMI 62, and the like to issue various notifications (presentation of various information) to the occupant (for example, the driver) of the host vehicle M. For example, when the control device 100 stops the lane change, the notification control unit 167 issues a notification indicating that the lane change is stopped (for example, see step S40 in FIG. 12). The notification indicating that the lane change is stopped is issued by, for example, displaying a message “the lane change is stopped” on the display device of the HMI 30, the navigation HMI 62, or the like.

### <Travel Control Unit 170>

In the control device 100, for example, a combination of the action plan generating unit 140 (including the lane change determination unit 150) of the first control unit 120, and the acquisition unit 162, the speed control unit 164, and the steering control unit 166 of the second control unit 160 constitutes the travel control unit 170.

When a lane change request of the driver is detected based on an operation of the driving operator 80 (for example, the blinker lever 81) by the driver, the travel control unit 170 executes control related to the lane change of the host vehicle M based on a recognition result of a travel state, a travel environment, or the like of the host vehicle M recognized by the recognition unit 130. For example, when the lane change request of the driver is detected, the travel control unit 170 determines whether the lane change is possible in consideration of travel states or the like of the host vehicle M and other vehicles in the surroundings of the host vehicle M, and starts the lane change when it is determined that the lane change is possible. The lane change executed by the control device 100 according to an instruction (lane change request) from the driver in this way is hereinafter also referred to as an “intended automatic lane change”.

The travel control unit 170 is configured to be able to execute travel speed control for controlling the travel speed of the host vehicle M based on a target speed set in advance by the driver, a manufacturer of the host vehicle M, or the like. Here, the travel speed control is control such that the travel speed of the host vehicle M is set to the target speed when a preceding vehicle M1 is not present in a travel lane of the host vehicle M (host lane L1 to be described later), and the travel speed of the host vehicle M is adjusted according to a travel speed of the preceding vehicle M1 when the preceding vehicle M1 is present in the travel lane of the host vehicle M. For example, when the preceding vehicle M1 is present in the travel lane of the host vehicle M during the execution of the travel speed control, the travel control unit 170 causes the host vehicle M to travel such that the travel speed of the host vehicle M is the target speed on a condition that an appropriate inter-vehicle distance may be ensured between the host vehicle M and the preceding vehicle M1. Therefore, if the preceding vehicle M1 traveling at a speed less than the target speed is present in the travel lane of the host vehicle M during the execution of the travel speed control, the host vehicle M may travel at substantially the same speed as the preceding vehicle M1 (that is, a speed less than the target speed) after the inter-vehicle distance with the preceding vehicle M1 reaches a predetermined distance.

Such travel speed control is generally referred to as “adaptive cruise control (ACC)”. In the present embodiment, the travel speed control is hereinafter also referred to as the “ACC”. By executing the ACC (that is, the travel speed control) by the travel control unit 170, the control device 100 may appropriately control the travel speed of the host vehicle M in consideration of the presence or absence of the preceding vehicle M1 in the travel lane of the host vehicle M (host lane L1 to be described later) and the travel speed thereof, and may reduce fatigue of the driver of the host vehicle M or the like while ensuring safety of the host vehicle M.

With reference to FIG. 1 again, the travel driving force output device 200 outputs, to driving wheels, a travel driving force (torque) for driving the vehicle to travel. The travel driving force output device 200 includes, for example, a combination of an internal combustion engine, an electric motor, a transmission, and the like, and an electronic control unit (ECU) configured to control them. The ECU controls the above configuration according to information received from the second control unit 160 or information received from the driving operator 80.

The brake device 210 includes, for example, a brake caliper, a cylinder that transmits a hydraulic pressure to the brake caliper, an electric motor that generates the hydraulic pressure in the cylinder, and a brake ECU. The brake ECU controls the electric motor according to the information received from the second control unit 160 or the information received from the driving operator 80, and outputs a braking torque to each wheel according to a braking operation.

The steering device 220 includes, for example, a steering ECU and an electric motor. The electric motor changes an orientation of a steered wheel, for example, by applying a force to a rack-and-pinion mechanism. The steering ECU drives the electric motor according to the information received from the second control unit 160 or the information received from the driving operator 80 to change the orientation of the steered wheel.

### <Steering Wheel 82 and Blinker Lever 81>

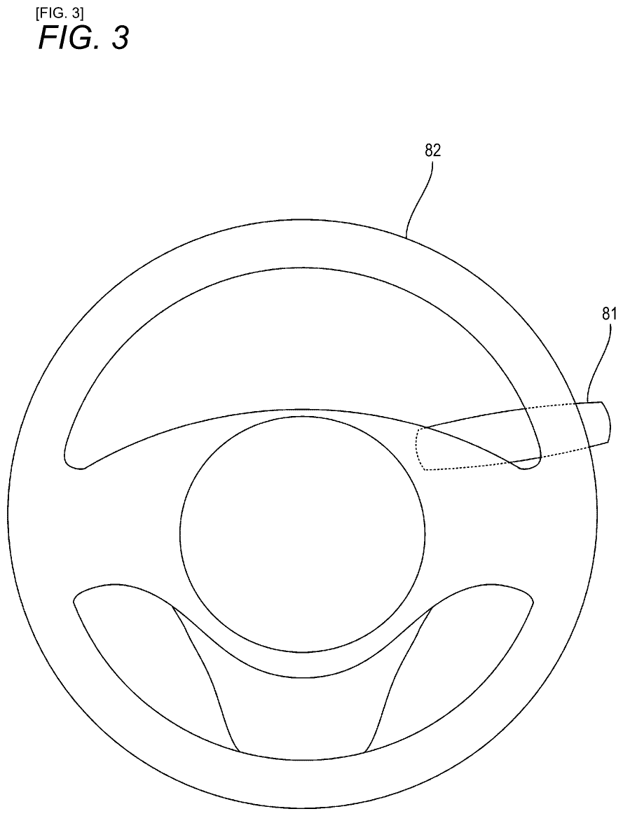

FIG. 3 is a diagram showing an example of the steering wheel 82 and the blinker lever 81. As shown in FIG. 3, the blinker lever 81 is, for example, an operator provided at a position and in a shape that allows the driver to perform a blind operation with one hand for gripping (for example, one finger of a right hand) while the driver grips the steering wheel 82.

### <Operation of Blinker Lever 81>

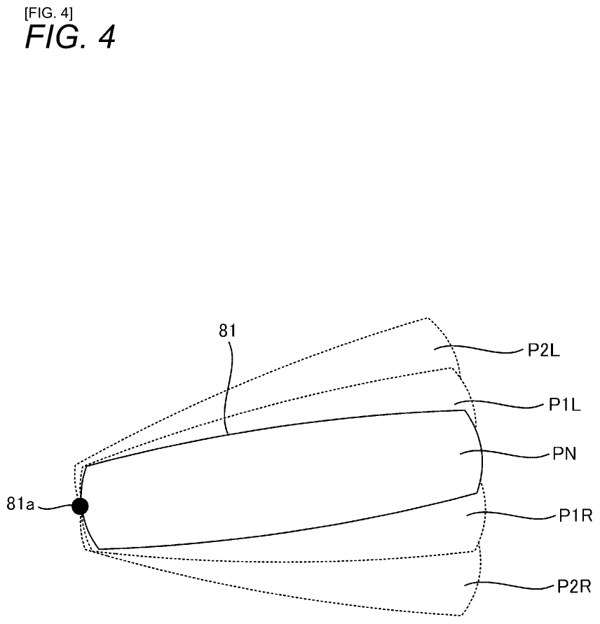

FIG. 4 is a diagram showing a specific example of an operation of the blinker lever 81. As shown in FIG. 4, the blinker lever 81 is pivotable around a support shaft 81a. A neutral position PN, shallow push positions P1L and P1R, and deep push positions P2L and P2R are positions at which the blinker lever 81 can be displaced by pivoting.

The neutral position PN is a position where the blinker lever 81 is not operated, and when the blinker lever 81 is in the neutral position PN, the blinker 83 is turned off.

The shallow push position P1L is a half-way position pivoted counterclockwise by a predetermined amount from the neutral position PN. The deep push position P2L is an end position pivoted further counterclockwise by a predetermined amount from the shallow push position P1L. The shallow push position P1R is a half-way position pivoted clockwise by a predetermined amount from the neutral position PN. The deep push position P2R is an end position pivoted further clockwise by a predetermined amount from the shallow push position P1R. The shallow push positions P1L and P1R are examples of a first position of the blinker lever 81. The deep push positions P2L and P2R are examples of a second position of the blinker lever 81.

When the blinker lever 81 is pushed down to the shallow push position P1L or P1R by the driver, a click feeling is given to the driver, and when an operation force to the blinker lever 81 is released from this state, the blinker lever 81 is mechanically returned to the neutral position PN by a return mechanism (not shown) such as a spring. When the blinker lever 81 is pushed down to the deep push position P2L or P2R by the driver, the blinker lever 81 is held at the deep push position P2L or P2R by a mechanical lock mechanism (not shown) even when an operation force is released.

The blinker lever 81 is provided with a switch (not shown). The travel control unit 170 may determine whether the blinker lever 81 is located at the neutral position PN, the shallow push position P1L or P1R, or the deep push position P2L or P2R based on a detection result by the switch.

In a state where the blinker lever 81 is held at the deep push position P2L or P2R, when the steering wheel 82 is reversely rotated and the blinker lever 81 is returned to the neutral position, or when the driver returns the blinker lever 81 in a neutral position direction, the lock by the lock mechanism is released and the blinker lever 81 is returned to the neutral position PN. That is, when the blinker lever 81 is operated to the deep push position P2L or P2R, the blinker lever 81 operates in the same manner as a blinker blinking device generally implemented in the related art.

Hereinafter, an operation of maintaining the blinker lever 81 at the shallow push position P1L or the shallow push position P1R is referred to as a “half-lock operation”. The half-lock operation is an example of the predetermined operation according to the present invention. For example, the control device 100 determines that there is a lane change request when the half-lock operation of the blinker lever 81 continues for a predetermined time or more. Here, the predetermined time is a time necessary for confirming an intention of the driver to execute the lane change, and is, for example, 1.0 [sec]. In this way, by receiving the lane change request based on an operation (for example, the half-lock operation) on the blinker lever 81, it is possible to receive the lane change request without providing an operation button or the like for receiving the lane change request separately from the blinker lever 81.

### <Lane Change Operation of Host Vehicle M>

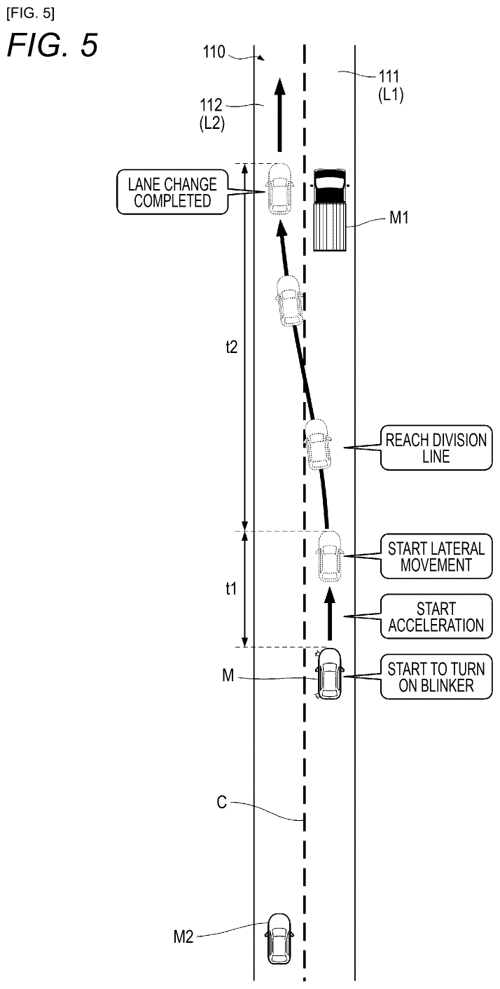

When there is a lane change request from the driver during the execution of the ACC, the control device 100 (for example, the travel control unit 170) may execute the lane change while maintaining the ACC. FIG. 5 shows an example of a lane change operation of the host vehicle M by the control device 100 during the execution of the ACC.

A road 110 shown in FIG. 5 has a right lane 111 and a left lane 112 in which a direction from a lower side to an upper side in FIG. 5 is a traveling direction. A division line C as a road division line is provided at a boundary between the right lane 111 and the left lane 112.

In the example shown in FIG. 5, the host vehicle M travels in the right lane 111 of the road 110 under the ACC. Hereinafter, the travel lane of the host vehicle M is also referred to as the “host lane L1”. The preceding vehicle M1 traveling at a lower speed than the target speed of the host vehicle M is present in the right lane 111 which is the host lane L1. The following vehicle M2 that is traveling is present in the left lane 112 adjacent to the right lane 111 which is the host lane L1. Hereinafter, a lane adjacent to the host lane L1 is also referred to as an “adjacent lane L2”.

In a case of the example shown in FIG. 5, if the host vehicle M keeps in the right lane 111 as it is, the host vehicle M also needs to continue to travel at a lower speed than the target speed due to an influence of the preceding vehicle M1, and thus the driver often desires to execute the lane change. In the example described here, it is also assumed that the driver desires to execute the lane change and issues a lane change request (for example, the above half-lock operation) to the control device 100.

In this way, in a case where there is a lane change request from the driver while the ACC is executed and the host vehicle M travels at a lower speed than the target speed, the control device 100 first starts to turn on the blinker 83 and accelerates the host vehicle M in the right lane 111 (host lane L1). That is, when the lane change is executed during the execution of the ACC (that is, the travel speed control), the control device 100 (for example, the travel control unit 170) accelerates the host vehicle M based on the target speed before movement to the adjacent lane L2 by the lane change is completed. Accordingly, it is possible to execute the lane change while ensuring the safety of the host vehicle M by preventing an inter-vehicle distance with the following vehicle M2 traveling in the adjacent lane L2 from being shortened.

Then, after a time t1 from the start of the acceleration, the control device 100 executes the lane change by further accelerating the host vehicle M and laterally moving the host vehicle M to the left lane 112 (adjacent lane L2). More specifically, when the lane change is executed during the execution of the ACC (that is, the travel speed control), the control device 100 (for example, the travel control unit 170) accelerates the host vehicle M to the target speed before the movement to the adjacent lane L2 by the lane change is completed.

As an example, in the present embodiment, the time t1 from the start of the acceleration to the start of the lateral movement in the host lane L1 is set to be 3 [sec]. A time t2 from the start of the lateral movement to the completion of the lateral movement (that is, completion of the lane change) is set to be 7 [sec]. That is, the control device 100 executes the lane change in 10 [sec] from the time when the blinker 83 is turned on according to the lane change request.

In the case where there is a lane change request from the driver while the ACC is executed and the host vehicle M travels at the lower speed than the target speed, the control device 100 executes the lane change while accelerating the host vehicle M at a constant acceleration, and causes the host vehicle M to reach the target speed when the lane change is completed. For example, as described above, in the case where the lane change is executed in 10 [sec], the acceleration of the host vehicle M at the time of the lane change is (target speed-speed immediately before starting lane change)/10 [km/s²].

In this way, in the case where the lane change is executed while the ACC is executed and the host vehicle M travels at the lower speed than the target speed, the host vehicle M is accelerated to the target speed before the movement to the adjacent lane L2 by the lane change is completed. Accordingly, it is possible to execute the lane change while ensuring the safety of the host vehicle M by preventing the inter-vehicle distance with the following vehicle M2 traveling in the adjacent lane L2 from being shortened. In a case where the host vehicle M is accelerated according to the execution of the lane change in this way, by making the acceleration constant, occurrence of an acceleration fluctuation unexpected by the driver at the time of the lane change is prevented, and it is possible to execute the lane change while avoiding the driver from feeling uneasy or uncomfortable.

### <Lane Change Determination Processing>

As shown in FIG. 5, if the following vehicle M2 traveling in the adjacent lane L2 is present when there is a lane change request, the lane change determination unit 150 determines whether the lane change is possible based on a relative speed between the host vehicle M and the following vehicle M2 and the inter-vehicle distance between the host vehicle M and the following vehicle M2.

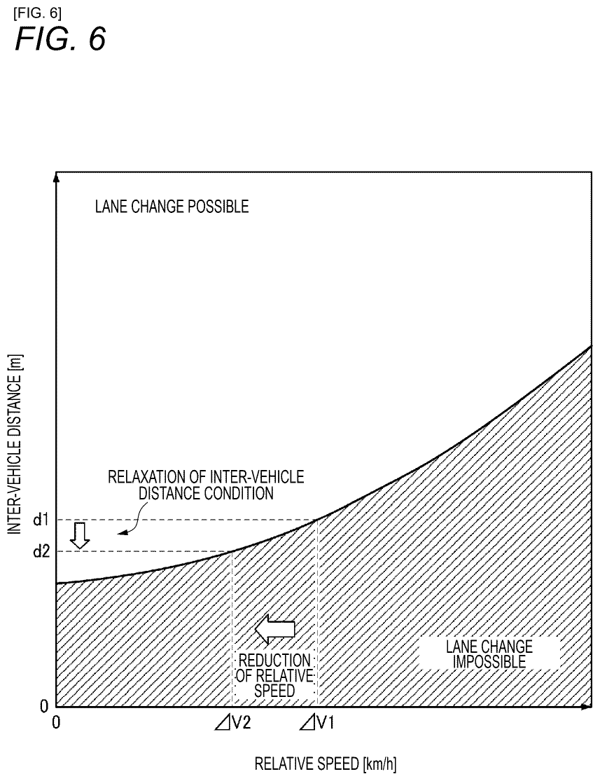

Specifically, in the present embodiment, as shown in FIG. 6, a minimum inter-vehicle distance at which the lane change is executable is set in advance for each relative speed. The lane change determination unit 150 first calculates the relative speed between the host vehicle M and the following vehicle M2 by subtracting a speed of the host vehicle M from a speed of the following vehicle M2, and compares a minimum inter-vehicle distance corresponding to the calculated relative speed with the inter-vehicle distance between the host vehicle M and the following vehicle M2. As a result, when the inter-vehicle distance between the host vehicle M and the following vehicle M2 is equal to or greater than the minimum inter-vehicle distance corresponding to the relative speed between the host vehicle M and the following vehicle M2, the lane change determination unit 150 determines that the lane change is possible. On the other hand, when the inter-vehicle distance between the host vehicle M and the following vehicle M2 is less than the minimum inter-vehicle distance corresponding to the relative speed between the host vehicle M and the following vehicle M2, the lane change determination unit 150 determines that the lane change is impossible.

As an example, in the present embodiment, when the relative speed between the host vehicle M and the following vehicle M2 is AV1, the minimum inter-vehicle distance at which the lane change is executable is d1. Therefore, in a case where the following vehicle M2 traveling in the adjacent lane L2 is present when there is a lane change request, and the relative speed between the host vehicle M and the following vehicle M2 is AV1, the lane change determination unit 150 determines that the lane change is possible when the inter-vehicle distance between the host vehicle M and the following vehicle M2 is d1 or more.

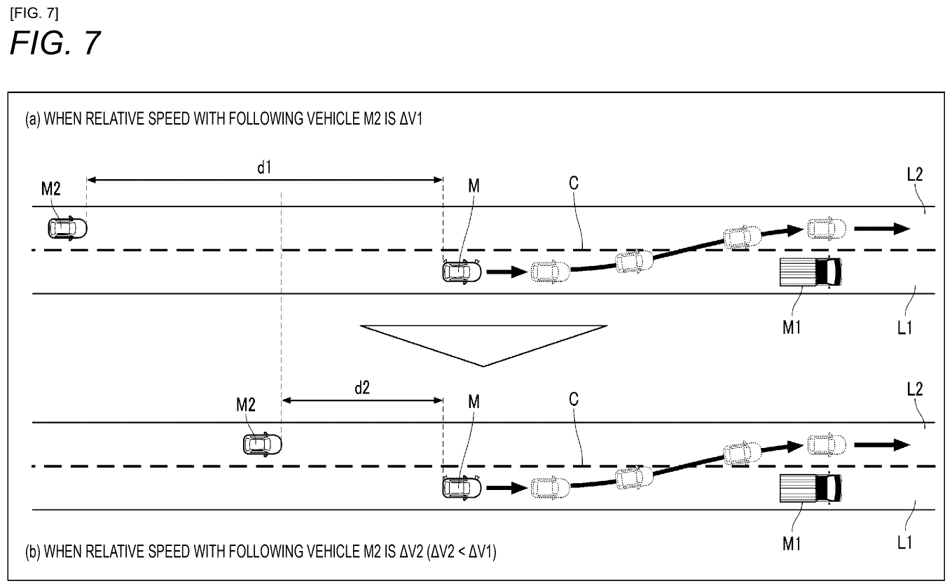

Therefore, in the present embodiment, as shown in (a) in FIG. 7, in a case where the relative speed between the host vehicle M and the following vehicle M2 is AV1 and the inter-vehicle distance between the host vehicle M and the following vehicle M2 is d1 or more, the lane change to the adjacent lane L2 is executed by the control device 100 (for example, the travel control unit 170) according to the lane change request.

As another example, in the present embodiment, when the relative speed between the host vehicle M and the following vehicle M2 is AV2 (where AV2<AV1), the minimum inter-vehicle distance at which the lane change is executable is d2 (where d2<d1). Therefore, in a case where the following vehicle M2 traveling in the adjacent lane L2 is present when there is a lane change request, and the relative speed between the host vehicle M and the following vehicle M2 is AV2, the lane change determination unit 150 determines that the lane change is possible when the inter-vehicle distance between the host vehicle M and the following vehicle M2 is d2 or more.

Therefore, in the present embodiment, as shown in (b) in FIG. 7, in a case where the relative speed between the host vehicle M and the following vehicle M2 is AV2 and the inter-vehicle distance between the host vehicle M and the following vehicle M2 is d2 or more, the lane change to the adjacent lane L2 is executed by the control device 100 (for example, the travel control unit 170) according to the lane change request.

In this way, in the present embodiment, as the relative speed between the host vehicle M and the following vehicle M2 is smaller, a condition of the inter-vehicle distance for determining whether the lane change is possible is more relaxed. In this way, when the relative speed between the host vehicle M and the following vehicle M2 is small and it is less likely to reduce the inter-vehicle distance between the host vehicle M and the following vehicle M2 at the time of the lane change (that is, when a possibility that the host vehicle M is rear-ended by the following vehicle M2 is low), it is possible to make it easy to execute the lane change according to the lane change request of the driver.

On the other hand, with the above configuration, when the relative speed between the host vehicle M and the following vehicle M2 is large, it may be difficult to execute the lane change even when the driver issues a lane change request. For example, as described above, when the preceding vehicle M1 traveling at a low speed is present in front of the host vehicle M executing the ACC, the host vehicle M may also travel at a low speed under the influence of the preceding vehicle M1. In such a case, the relative speed between the host vehicle M and the following vehicle M2 becomes large, and it may be difficult to execute the lane change even when the driver issues a lane change request. From the viewpoint of marketability of the host vehicle M, as far as the safety of the host vehicle M is ensured, it is desired to execute the lane change as desired by the driver as much as possible.

Therefore, while the travel speed control (that is, the AAC) is being executed, the lane change determination unit 150 determines whether the lane change is possible based on a relative speed with another vehicle (for example, the following vehicle M2 traveling in the adjacent lane L2 which is a lane change destination) in a case where the target speed is the travel speed of the host vehicle M. Accordingly, it is possible to appropriately determine whether the lane change is possible in consideration of the acceleration based on the target speed that is possible due to the lane change, and it is possible to increase an opportunity to execute the lane change while ensuring the safety of the host vehicle M.

For example, it is assumed that there is a lane change request when the ACC in which the target speed is set to be 100 [km/h] is executed and the host vehicle M travels at 85 [km/h]. At this time, it is assumed that the following vehicle M2 traveling at 115 [km/h] is present in the adjacent lane L2 which is the lane change destination. In such a situation, when a current speed of the host vehicle M (that is, 85 [km/h]) is used to calculate the relative speed between the host vehicle M and the following vehicle M2, the relative speed between the host vehicle M and the following vehicle M2 is 30 [km/h].

On the other hand, when the target speed (that is, 100 [km/h]) is used to calculate the relative speed between the host vehicle M and the following vehicle M2, the relative speed between the host vehicle M and the following vehicle M2 is 15 [km/h]. Therefore, by using the target speed in the calculation of the relative speed between the host vehicle M and the following vehicle M2, the calculated relative speed may be made smaller than when the current speed of the host vehicle M is used, and it is possible to make it easy to execute the lane change even when the inter-vehicle distance between the host vehicle M and the following vehicle M2 is short.

In this way, in the case where there is a lane change request from the driver while the ACC is executed and the host vehicle M travels at the lower speed than the target speed, the lane change determination unit 150 calculates a relative speed with another vehicle based on the target speed in the ACC and determines whether the lane change is possible. Accordingly, even when the host vehicle M travels at a low speed under the influence of the preceding vehicle M1 in the host lane L1 or the like, the control device 100 may appropriately determine whether the lane change is possible in consideration of the acceleration based on the target speed that may be performed after the lane change, and it is possible to increase the opportunity to execute the lane change while ensuring the safety of the host vehicle M. Therefore, the marketability of the host vehicle M may be improved.

### <Processing Executed by Control Device 100>

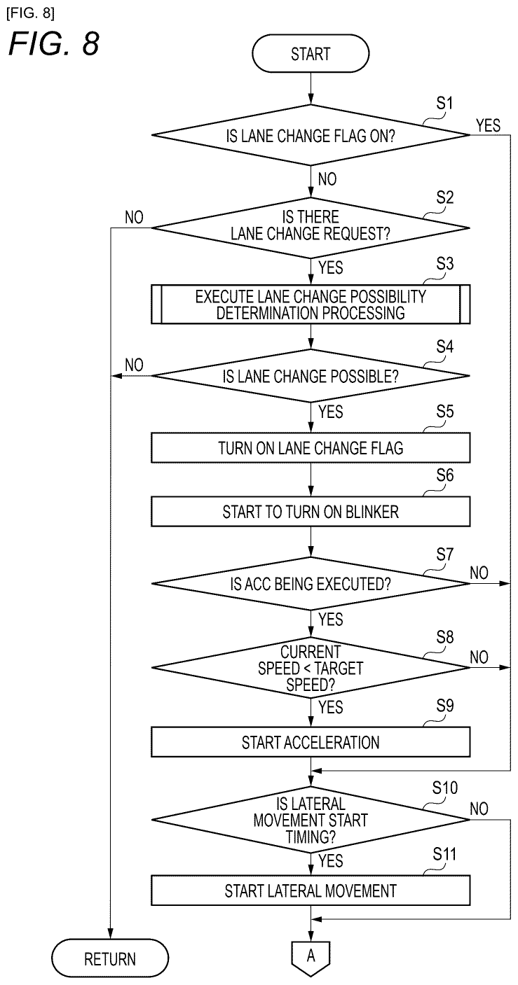

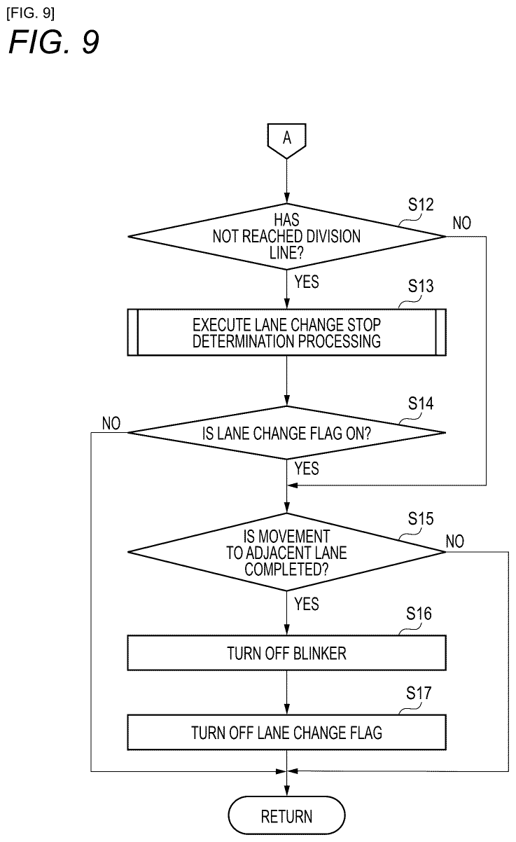

Hereinafter, a specific example of processing executed by the control device 100 will be described with reference to FIGS. 8 to 12. For example, when an ignition power supply of the host vehicle M is turned on, the control device 100 repeatedly executes lane change assistance processing shown in FIGS. 8 and 9 at a predetermined cycle.

As shown in FIG. 8, the control device 100 first determines whether a lane change flag indicating that a lane change is being executed by the control device 100 is ON (step S1). When it is determined that the lane change flag is ON (step S1: Yes), the control device 100 proceeds to processing of step S10 to be described later. On the other hand, when it is determined that the lane change flag is OFF (step S1: No), the control device 100 determines whether there is a lane change request from the driver (step S2).

When it is determined that there is no lane change request (step S2: No), the control device 100 ends the current lane change assistance processing as it is. On the other hand, when it is determined that there is a lane change request (step S2: Yes), the control device 100 proceeds to lane change possibility determination processing (step S3) of determining whether the lane change is possible.

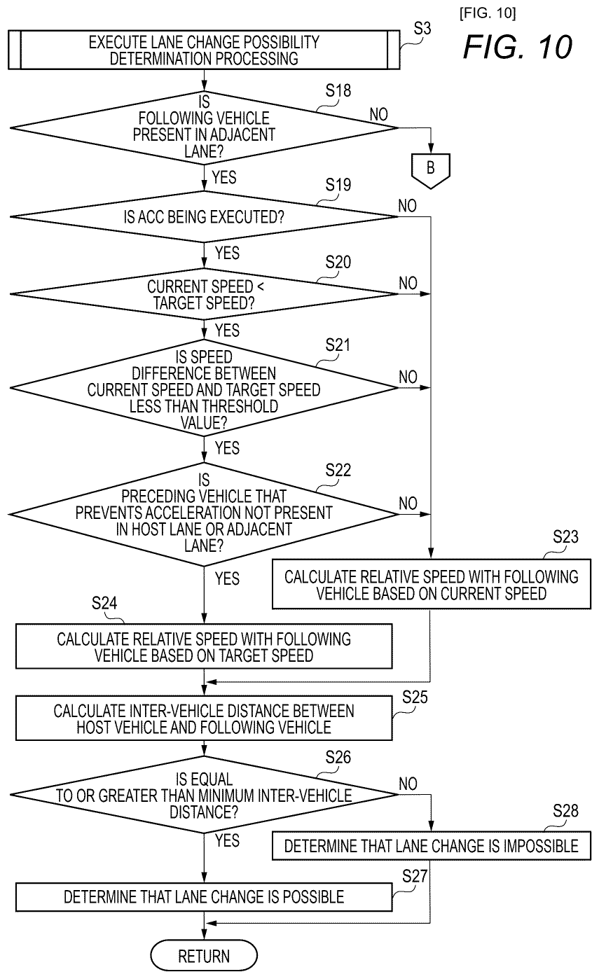

As shown in FIG. 10, in the lane change possibility determination processing (step S3), the control device 100 first determines whether the following vehicle M2 is present in the adjacent lane L2 which is the lane change destination (step S18). When it is determined that the following vehicle M2 is present in the adjacent lane L2 which is the lane change destination (step S18: Yes), the control device 100 determines whether the ACC is being executed (step S19).

When it is determined that the ACC is being executed (step S19: Yes), the control device 100 determines whether a current speed of the host vehicle M is less than the target speed (step S20). When it is determined that the current speed of the host vehicle M is less than the target speed (step S20: Yes), the control device 100 determines whether a speed difference between the current speed of the host vehicle M and the target speed is less than a predetermined threshold value (step S21). The threshold value is set in advance for the control device 100 by, for example, a manufacturer of the host vehicle M.

When it is determined that the speed difference between the current speed of the host vehicle M and the target speed is less than the threshold value (step S21: Yes), the control device 100 determines whether the preceding vehicle M1 that prevents acceleration based on the target speed of the host vehicle M is not present in the host lane L1 or the adjacent lane L2 (step S22). Examples of the preceding vehicle M1 that prevents the acceleration based on the target speed of the host vehicle M include the preceding vehicle M1 whose inter-vehicle distance with the host vehicle M is equal to or less than a predetermined value. The preceding vehicle M1 that prevents the acceleration based on the target speed of the host vehicle M may be the preceding vehicle M1 or the like whose inter-vehicle distance with the host vehicle M is equal to or less than the predetermined value and whose relative speed when the target speed is a travel speed of the host vehicle M is equal to or less than a predetermined value (for example, a negative value).

When it is determined that the preceding vehicle M1 that prevents the acceleration of the host vehicle M is not present in either the host lane L1 or the adjacent lane L2 (step S22: Yes), the control device 100 calculates a relative speed between the host vehicle M and the following vehicle M2 based on the target speed (step S24). That is, in this case, the control device 100 calculates the relative speed with the following vehicle M2 when the target speed is the travel speed of the host vehicle M.

On the other hand, when it is determined that the ACC is not being executed in processing of step S19 (step S19: No), when it is determined that the current speed of the host vehicle M is equal to or greater than the target speed in processing of step S20 (step S20: No), when it is determined that the speed difference between the current speed of the host vehicle M and the target speed is equal to or greater than the threshold value in processing of step S21 (step S21: No), or when it is determined that the preceding vehicle M1 that prevents the acceleration of the host vehicle M is present in the host lane L1 or the adjacent lane L2 in processing of step S22 (step S22: No), the control device 100 calculates a relative speed between the host vehicle M and the following vehicle M2 based on the current speed of the host vehicle M (step S23).

Next, the control device 100 calculates an inter-vehicle distance between the host vehicle M and the following vehicle M2 (step S25), and determines whether the inter-vehicle distance is equal to or greater than a minimum inter-vehicle distance corresponding to the relative speed calculated in processing of step S23 or step S24 (step S26).

When it is determined that the inter-vehicle distance between the host vehicle M and the following vehicle M2 is equal to or greater than the minimum inter-vehicle distance (step S26: Yes), the control device 100 determines that the lane change is possible (step S27) and ends the lane change possibility determination processing. On the other hand, when it is determined that the inter-vehicle distance between the host vehicle M and the following vehicle M2 is less than the minimum inter-vehicle distance (step S26: No), the control device 100 determines that the lane change is impossible (step S28) and ends the lane change possibility determination processing.

As described above, while the ACC is executed (step S19: Yes), when the following vehicle M2 is present in the adjacent lane L2 which is the lane change destination (step S18: Yes), and when the preceding vehicle M1 that prevents the acceleration based on the target speed of the host vehicle M is present in the adjacent lane L2 (step S22: No), the control device 100 (for example, the lane change determination unit 150) determines whether the lane change is possible based on the relative speed with the following vehicle M2 according to the current speed of the host vehicle M (step S26 to step S28). Accordingly, when the preceding vehicle M1 that prevents the acceleration based on the target speed of the host vehicle M is present in the adjacent lane L2, it is possible to ensure the safety of the host vehicle M by preventing the execution of the lane change accompanied by the acceleration based on the target speed.

While the ACC is executed, when the following vehicle M2 is present in the adjacent lane L2 which is the lane change destination, and when the preceding vehicle M1 that prevents the acceleration based on the target speed of the host vehicle M is present in the adjacent lane L2, the control device 100 (for example, the lane change determination unit 150) may uniformly determine that the lane change is impossible. Also in this way, when the preceding vehicle M1 that prevents the acceleration based on the target speed of the host vehicle M is present in the adjacent lane L2, it is possible to ensure the safety of the host vehicle M by preventing the execution of the lane change accompanied by the acceleration based on the target speed.

Also while the ACC is executed, the following vehicle M2 is present in the adjacent lane L2 which is the lane change destination, and the preceding vehicle M1 that prevents the acceleration based on the target speed of the host vehicle M is present in the host lane L1 (step S22: No), the control device 100 (for example, the lane change determination unit 150) determines whether the lane change is possible based on the relative speed with the following vehicle M2 according to the current speed of the host vehicle M (step S26 to step S28). Accordingly, when the preceding vehicle M1 that prevents the acceleration based on the target speed of the host vehicle M is present in the host lane L1, it is possible to ensure the safety of the host vehicle M by preventing the execution of the lane change accompanied by the acceleration based on the target speed.

While the ACC is executed, when the following vehicle M2 is present in the adjacent lane L2 which is the lane change destination, and the preceding vehicle M1 that prevents the acceleration based on the target speed of the host vehicle M is present in the host lane L1, the control device 100 (for example, the lane change determination unit 150) may uniformly determine that the lane change is impossible. Also in this way, when the preceding vehicle M1 that prevents the acceleration based on the target speed of the host vehicle M is present in the host lane L1, it is possible to ensure the safety of the host vehicle M by preventing the execution of the lane change accompanied by the acceleration based on the target speed.

When the ACC is being executed (step S19: Yes), when the current speed of the host vehicle M is less than the target speed (step S20: Yes), and when the speed difference between the current speed of the host vehicle M and the target speed is equal to or greater than the predetermined threshold value (step S21: No), the control device 100 (for example, the lane change determination unit 150) determines whether the lane change is possible based on the relative speed with the following vehicle M2 according to the current speed of the host vehicle M (step S26 to step S28). Accordingly, it is possible to prevent a lane change in which rapid acceleration may occur. That is, in a case where the speed difference between the current speed of the host vehicle M and the target speed is equal to or greater than the threshold value, when the lane change accompanied by the acceleration based on the target speed is executed, an acceleration at the time of the lane change is excessive, and the rapid acceleration may occur at the time of the lane change. If the rapid acceleration occurs at the time of the lane change, the driver of the host vehicle M is made to be uneasy, or noise and vibration (NV) characteristics of the host vehicle M are deteriorated.

Therefore, as described above, when the speed difference between the current speed of the host vehicle M and the target speed is equal to or greater than the threshold value, the control device 100 determines whether the lane change is possible based on the relative speed with the following vehicle M2 according to the current speed of the host vehicle M, thereby allowing the execution of the lane change only when the lane change is executable without performing the acceleration based on the target speed. Accordingly, it is possible to prevent the execution of the lane change that may cause the rapid acceleration, to avoid the driver from feeling uneasy or the NV characteristics of the host vehicle M from being deteriorated, and to improve the marketability of the host vehicle M.

When the ACC is being executed, when the current speed of the host vehicle M is less than the target speed, and when the speed difference between the current speed of the host vehicle M and the target speed is equal to or greater than the predetermined threshold value, the control device 100 (for example, the lane change determination unit 150) may uniformly determine that the lane change is impossible. Also in this way, it is possible to prevent the execution of the lane change that may cause the rapid acceleration, to avoid the driver from feeling uneasy or the NV characteristics of the host vehicle M from being deteriorated, and to improve the marketability of the host vehicle M.

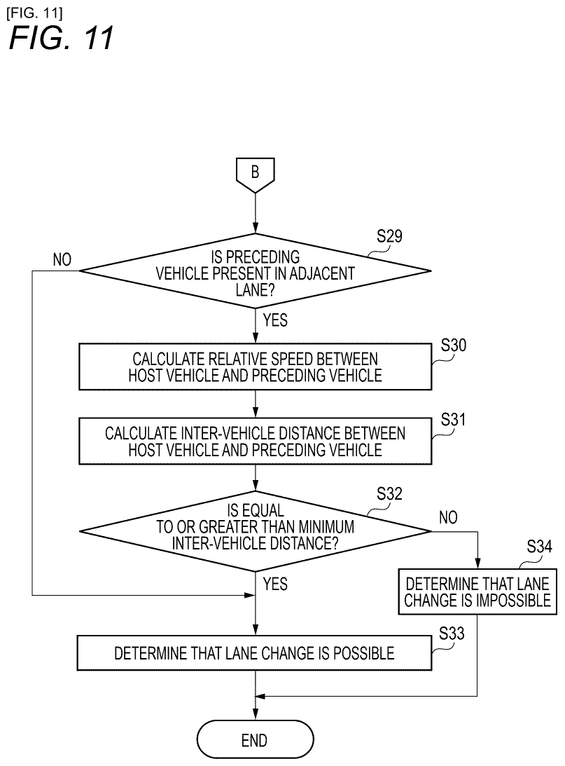

In processing of step S18, when it is determined that the following vehicle M2 is not present in the adjacent lane L2 which is the lane change destination (step S18: No), as shown in FIG. 11, the control device 100 determines whether the preceding vehicle M1 is present in the adjacent lane L2 which is the lane change destination (step S29).

When it is determined that the preceding vehicle M1 is not present in the adjacent lane L2 which is the lane change destination (step S29: No), the control device 100 proceeds to processing of step S33. On the other hand, when it is determined that the preceding vehicle M1 is present in the adjacent lane L2 which is the lane change destination (step S29: Yes), the control device 100 calculates a relative speed between the host vehicle M and the preceding vehicle M1 (step S30). For the calculation of the relative speed between the host vehicle M and the preceding vehicle M1, for example, the current speed of the host vehicle M is used. When the ACC is executed, the target speed may be used to calculate the relative speed between the host vehicle M and the preceding vehicle M1.

Next, the control device 100 calculates an inter-vehicle distance between the host vehicle M and the preceding vehicle M1 (step S31), and determines whether the inter-vehicle distance is equal to or greater than a minimum inter-vehicle distance corresponding to the relative speed calculated in processing of step S30 (step S32).

When it is determined that the inter-vehicle distance between the host vehicle M and the preceding vehicle M1 is equal to or greater than the minimum inter-vehicle distance (step S32: Yes), the control device 100 determines that the lane change is possible (step S33) and ends the lane change possibility determination processing. On the other hand, when it is determined that the inter-vehicle distance between the host vehicle M and the preceding vehicle M1 is less than the minimum inter-vehicle distance (step S32: No), the control device 100 determines that the lane change is impossible (step S34) and ends the lane change possibility determination processing.

After the lane change possibility determination processing (step S3) shown in FIGS. 10 and 11 is executed, the control device 100 determines whether a determination result of the lane change possibility determination processing is that the lane change is possible (step S4) as shown in FIG. 8. When the determination result of the lane change possibility determination processing is that the lane change is impossible (step S4: No), the control device 100 ends the current lane change assistance processing as it is.

On the other hand, when the determination result of the lane change possibility determination processing is that the lane change is possible (step S4: Yes), the control device 100 turns on the lane change flag (step S5) and starts to turn on the blinker 83 (step S6).

Next, the control device 100 determines whether the ACC is being executed (step S7). When it is determined that the ACC is not being executed (step S7: No), the control device 100 proceeds to the processing of step S10 to be described later. When it is determined that the ACC is being executed (step S7: Yes), the control device 100 determines whether the current speed of the host vehicle M is less than the target speed (step S8).

When it is determined that the current speed of the host vehicle M is not less than the target speed (step S8: No), the control device 100 proceeds to the processing of step S10 to be described later. When it is determined that the current speed of the host vehicle M is less than the target speed (step S8: Yes), the control device 100 starts the acceleration based on the target speed (step S9).

Next, the control device 100 determines whether it is a lateral movement start timing (step S10). When it is determined that it is not the lateral movement start timing (step S10: No), the control device 100 proceeds to processing of step S12 to be described later as it is. On the other hand, when it is determined that it is the lateral movement start timing (step S10: Yes), the lateral movement is started (step S11), and the processing proceeds to step S12.

Next, as shown in FIG. 9, the control device 100 determines whether the host vehicle M has not reached the division line C of the boundary between the host lane L1 and the adjacent lane L2 which is the lane change destination (step S12). When the host vehicle M has reached the division line C (step S12: No), the control device 100 proceeds to processing of step S15 to be described later as it is. On the other hand, when the host vehicle M has not reached the division line C yet (step S12: Yes), the control device 100 executes lane change stop determination processing (step S13) shown in FIG. 12.

As shown in FIG. 12, in the lane change stop determination processing (step S13), the control device 100 first determines whether another vehicle (for example, the following vehicle M2) is present in the adjacent lane L2 which is the lane change destination (step S35). When it is determined that the another vehicle is not present in the adjacent lane L2 which is the lane change destination (step S35: No), the control device 100 ends the lane change stop determination processing as it is.

On the other hand, when it is determined that the another vehicle is present in the adjacent lane L2 which is the lane change destination (step S35: Yes), the control device 100 calculates a relative speed between the host vehicle M and the another vehicle present in the adjacent lane L2 (step S36). For the calculation of the relative speed between the host vehicle M and the another vehicle, for example, the current speed of the host vehicle M is used.

Next, the control device 100 calculates an inter-vehicle distance between the host vehicle M and the another vehicle present in the adjacent lane L2 (step S37), and determines whether the inter-vehicle distance is equal to or less than a threshold value that is a lane change stop condition (step S38).

When it is determined that the inter-vehicle distance between the host vehicle M and the another vehicle present in the adjacent lane L2 is not equal to or less than the threshold value which is the lane change stop condition (step S38: No), the control device 100 ends the lane change stop determination processing as it is.

On the other hand, when it is determined that the inter-vehicle distance between the host vehicle M and the another vehicle present in the adjacent lane L2 is equal to or less than the threshold value which is the lane change stop condition (step S38: Yes), the control device 100 stops the lane change and returns the host vehicle M to a center of the host lane L1 (step S39).

Then, the control device 100 notifies the driver that the lane change is stopped (step S40), turns off the lane change flag (step S41), and ends the lane change stop determination processing.

In this way, when the inter-vehicle distance between the host vehicle M and the another vehicle (for example, the following vehicle M2) traveling in the adjacent lane L2 becomes short before the host vehicle M reaches the division line C, that is, before the host vehicle M deviates from the host lane L1, the control device 100 stops the lane change. The safety of the host vehicle M may be ensured accordingly.

After the lane change stop determination processing (step S13) shown in FIG. 12 is executed, the control device 100 determines whether the lane change flag is ON (step S14) as shown in FIG. 8. When it is determined that the lane change flag is OFF (step S14: No), the control device 100 ends the current lane change assistance processing as it is.

On the other hand, when it is determined that the lane change flag is ON (step S14: Yes), the control device 100 determines whether movement to the adjacent lane L2 which is the lane change destination is completed (step S15). When it is determined that the movement to the adjacent lane L2 is completed (step S15: Yes), the control device 100 turns off the blinker 83 (step S16), turns off the lane change flag (step S17), and ends the current lane change assistance processing. On the other hand, when it is determined that the movement to the adjacent lane L2 is not completed (step S15: No), the control device 100 ends the current lane change assistance processing as it is.

As described above, according to the present embodiment, during the execution of the travel speed control (that is, the ACC), it is possible to determine whether the lane change is possible based on the relative speed with the another vehicle (for example, the following vehicle M2) when the target speed is the travel speed of the host vehicle M. Accordingly, even when the host vehicle M travels at a low speed due to the influence of the preceding vehicle M1 in the host lane L1 or the like, it is possible to appropriately determine whether the lane change is possible in consideration of the acceleration based on the target speed that is possible due to the lane change, and it is possible to increase the opportunity to execute the lane change while ensuring the safety of the host vehicle M.

Although an embodiment of the present invention has been described above with reference to the drawings, it goes without saying that the present invention is not limited to the embodiment described above. It is apparent that those skilled in the art may conceive of various modifications and changes within the scope described in the claims, and it is understood that such modifications and changes naturally fall within the technical scope of the present invention. Further, the constituent elements in the embodiment described above may be combined freely in a scope not departing from the gist of the invention.

For example, in the embodiment described above, the example in which the predetermined operation as the lane change request is the half-lock operation of the blinker lever 81 has been described, but the present invention is not limited thereto. The predetermined operation as the lane change request is not limited to the half-lock operation of the blinker lever 81, and may be any operation using various operators. As an example, an automatic lane change button may be provided on the steering wheel 82, and the predetermined operation as the lane change request may be performed by pressing this button.

The control device 100 may propose the execution of the lane change to the driver based on the speed difference between the current speed of the host vehicle M and the target speed during the execution of the ACC. For example, when the current speed of the host vehicle M is less than the target speed and the speed difference between the current speed of the host vehicle M and the target speed is equal to or greater than the predetermined threshold value during the execution of the ACC, it is assumed that the host vehicle M travels at a low speed due to the influence of the preceding vehicle M1 or the like. Therefore, when the current speed of the host vehicle M is less than the target speed and the speed difference between the current speed of the host vehicle M and the target speed is equal to or greater than the threshold value during the execution of the ACC, the control device 100 may propose the execution of the lane change to the driver in order to enable traveling at the target speed. In this way, it is possible to prompt the driver to appropriately execute the lane change, improve convenience of the driver, and improve the marketability of the host vehicle M.

In the embodiment described above, the control device 100 executes the lane change when there is a lane change request from the driver, but the present invention is not limited thereto. For example, regardless of the presence or absence of the lane change request from the driver, the control device 100 may appropriately determine the necessity of the lane change based on travel states of other vehicles, a route to a destination, or the like, and may automatically execute the lane change when it is determined that the lane change is necessary.

More specifically, for example, the control device 100 may automatically execute the lane change when the ACC is being executed and the preceding vehicle M1 traveling at a lower speed than the target speed of the host vehicle M is present in the host lane L1. As a specific example, when the current speed of the host vehicle M is less than the target speed and the speed difference between the current speed of the host vehicle M and the target speed is equal to or greater than the threshold value during the execution of the ACC, the control device 100 may automatically execute the lane change in order to enable traveling at the target speed. Also in a case where the lane change is configured to be automatically executable during the execution of the ACC, when the following vehicle M2 is present in the adjacent lane L2, the control device 100 may determine whether the lane change is possible based on the relative speed with the following vehicle M2 when the target speed is the travel speed of the host vehicle M. Since the control device 100 is configured to be able to automatically execute the lane change in this way, it is possible to automatically execute an appropriate lane change, improve the convenience of the driver, and improve the marketability of the host vehicle M.

When the lane change is automatically executed, the control device 100 may notify the driver that the lane change is to be executed. In this way, it is possible to avoid the driver from feeling uneasy or uncomfortable due to the lane change being executed without prior notice.

In the present specification and the like, at least the following matters are described. Although corresponding constituent elements and the like in the embodiment described above are shown in parentheses, the present invention is not limited thereto.
(1) A lane change assistance device (control device 100) capable of executing a lane change of a host vehicle (host vehicle M) from a host lane (host lane L1) on which the host vehicle travels to an adjacent lane (adjacent lane L2) adjacent to the host lane, the lane change assistance device including:
a recognition unit (recognition unit 130) configured to recognize a surrounding situation of the host vehicle;
a lane change determination unit (lane change determination unit 150) configured to determine, when another vehicle traveling in the adjacent lane is detected by the recognition unit, whether the lane change is possible based on a relative speed between the host vehicle and the another vehicle and an inter-vehicle distance between the host vehicle and the another vehicle; and
a travel control unit (travel control unit 170) configured to execute the lane change based on a determination result of the lane change determination unit, in which
the travel control unit is configured to further execute travel speed control (ACC) for controlling a travel speed of the host vehicle based on a target speed set in advance, and
the lane change determination unit is configured to determine, while the travel speed control is being executed, whether the lane change is possible based on the relative speed when the target speed is the travel speed of the host vehicle.

According to (1), even when the host vehicle travels at a low speed due to an influence of a preceding vehicle in the host lane or the like, it is possible to appropriately determine whether the lane change is possible in consideration of acceleration based on the target speed that is possible due to the lane change, and it is possible to increase an opportunity to execute the lane change while ensuring safety of the host vehicle.
(2) The lane change assistance device according to (1), in which
the another vehicle is a following vehicle traveling behind the host vehicle.

According to (2), it is possible to appropriately determine whether the lane change is possible even when the following vehicle traveling in the adjacent lane is present.
(3) The lane change assistance device according to (2), in which
the travel speed control is control to set the travel speed of the host vehicle to the target speed when a preceding vehicle traveling in front of the host vehicle is not present in the host lane, and to adjust the travel speed of the host vehicle according to a travel speed of the preceding vehicle when the preceding vehicle is present in the host lane.

According to (3), by the travel speed control, the travel speed of the host vehicle may be appropriately controlled in consideration of the presence or absence of the preceding vehicle in the host lane and the travel speed thereof, and thus it is possible to reduce fatigue of a driver of the host vehicle or the like while ensuring the safety of the host vehicle.
(4) The lane change assistance device according to (3), in which
the travel control unit is configured to accelerate, when executing the lane change during the execution of the travel speed control, the host vehicle based on the target speed before completion of movement to the adjacent lane by the lane change.

According to (4), since the host vehicle is accelerated based on the target speed before the completion of the movement to the adjacent lane by the lane change, an inter-vehicle distance between the host vehicle and the following vehicle traveling in the adjacent lane is prevented from being shortened, and the lane change may be executed while ensuring the safety of the host vehicle.
(5) The lane change assistance device according to (4), in which
the travel control unit is configured to accelerate, when executing the lane change during the execution of the travel speed control, the host vehicle to the target speed before the completion of the movement to the adjacent lane by the lane change.

According to (5), since the host vehicle is accelerated to the target speed before the completion of the movement to the adjacent lane by the lane change, the inter-vehicle distance between the host vehicle and the following vehicle traveling in the adjacent lane is prevented from being shortened, and the lane change may be executed while ensuring the safety of the host vehicle.
(6) The lane change assistance device according to any one of (3) to (5), in which
in a case where the travel speed control is being executed and a preceding vehicle that prevents acceleration based on the target speed of the host vehicle is further present in the adjacent lane, the lane change determination unit determines not to execute the lane change.

According to (6), when the preceding vehicle that prevents the acceleration of the host vehicle is present in the adjacent lane, it is possible to ensure the safety of the host vehicle by preventing the execution of the lane change accompanied by the acceleration based on the target speed.
(7) The lane change assistance device according to any one of (3) to (6), in which
in a case where the travel speed control is being executed and a preceding vehicle that prevents acceleration based on the target speed of the host vehicle is further present in the host lane, the lane change determination unit determines not to execute the lane change.

According to (7), when the preceding vehicle that prevents the acceleration of the host vehicle is present in the host lane, it is possible to ensure the safety of the host vehicle by preventing the execution of the lane change accompanied by the acceleration based on the target speed.
(8) The lane change assistance device according to any one of (3) to (7), in which
when the travel speed control is being executed and a speed difference between a current travel speed of the host vehicle and the target speed is equal to or greater than a threshold value, the lane change determination unit determines not to execute the lane change.

When rapid acceleration occurs at the time of the lane change, the driver of the host vehicle may be made to be uneasy, or noise and vibration (NV) characteristics of the host vehicle may be deteriorated. According to (8), it is possible to prevent the execution of the lane change in which the rapid acceleration may occur, to avoid the driver of the host vehicle from feeling uneasy or the NV characteristics of the host vehicle from being deteriorated, and to improve the marketability of the host vehicle.
(9) The lane change assistance device according to any one of (3) to (8), further including:
a notification control unit (notification control unit 167) configured to propose, when the travel speed control is being executed and the preceding vehicle is present in the host lane, the lane change to a driver of the host vehicle based on a speed difference between a current travel speed of the host vehicle and the target speed.

According to (9), it is possible to prompt the driver to appropriately execute the lane change, improve convenience of the driver, and improve the marketability of the host vehicle.
(10) The lane change assistance device according to any one of (1) to (9), in which
when there is a lane change request from a driver of the host vehicle, the lane change determination unit determines whether the lane change is possible.

According to (10), it is possible to avoid execution of a lane change against the driver's will.
(11) The lane change assistance device according to (10), in which
the lane change request is a predetermined operation for a blinker lever (blinker lever 81) of the host vehicle,
a position at which the blinker lever is movable includes
a neutral position,
a first position that is located in each of two directions different from each other with respect to the neutral position, and returns to the neutral position when the driver does not apply an operation force to the blinker lever, and
a second position that is located in each of two directions with respect to the neutral position, has an amount of movement from the neutral position greater than that of the first position, and is capable of being maintained when the driver does not apply an operation force to the blinker lever, and
the predetermined operation is an operation of maintaining the blinker lever at the first position.

According to (11), it is possible to receive the lane change request without providing an operation button or the like for receiving the lane change request separately from the blinker lever.
(12) The lane change assistance device according to any one of (1) to (11), in which
in a case where the lane change is being executed and the inter-vehicle distance is equal to or less than a threshold value before the host vehicle reaches a division line configured to divide the host lane and the adjacent lane, the travel control unit stops the lane change.

According to (12), when the inter-vehicle distance between the host vehicle and the following vehicle traveling in the adjacent lane becomes short before the host vehicle reaches the division line (that is, before the host vehicle deviates from the host lane), the lane change is stopped, and thus the safety of the host vehicle may be ensured.

### REFERENCE SIGNS LIST

81: blinker lever
100: control device (lane change assistance device)
130: recognition unit
150: lane change determination unit
170: travel control unit
167: notification control unit
L1: host lane
L2: adjacent lane
M: host vehicle
M1: preceding vehicle (another vehicle)
M2: following vehicle (another vehicle)

1. A lane change assistance device capable of executing a lane change of a host vehicle from a host lane on which the host vehicle travels to an adjacent lane adjacent to the host lane, the lane change assistance device comprising:
a recognition unit configured to recognize a surrounding situation of the host vehicle;
a lane change determination unit configured to determine, when another vehicle traveling in the adjacent lane is detected by the recognition unit, whether the lane change is possible based on a relative speed between the host vehicle and the another vehicle and an inter-vehicle distance between the host vehicle and the another vehicle; and
a travel control unit configured to execute the lane change based on a determination result of the lane change determination unit, wherein
the travel control unit is configured to further execute travel speed control for controlling a travel speed of the host vehicle based on a target speed set in advance, and
the lane change determination unit is configured to determine, while the travel speed control is being executed, whether the lane change is possible based on the relative speed when the target speed is the travel speed of the host vehicle.

2. The lane change assistance device according to claim 1, wherein
the another vehicle is a following vehicle traveling behind the host vehicle.

3. The lane change assistance device according to claim 2, wherein
the travel speed control is control to set the travel speed of the host vehicle to the target speed when a preceding vehicle traveling in front of the host vehicle is not present in the host lane, and to adjust the travel speed of the host vehicle according to a travel speed of the preceding vehicle when the preceding vehicle is present in the host lane.

4. The lane change assistance device according to claim 3, wherein
the travel control unit is configured to accelerate, when executing the lane change during the execution of the travel speed control, the host vehicle based on the target speed before completion of movement to the adjacent lane by the lane change.

5. The lane change assistance device according to claim 4, wherein
the travel control unit is configured to accelerate, when executing the lane change during the execution of the travel speed control, the host vehicle to the target speed before the completion of the movement to the adjacent lane by the lane change.

6. The lane change assistance device according to claim 3, wherein
in a case where the travel speed control is being executed and a preceding vehicle that prevents acceleration based on the target speed of the host vehicle is further present in the adjacent lane, the lane change determination unit determines not to execute the lane change.

7. The lane change assistance device according to claim 3, wherein
in a case where the travel speed control is being executed and a preceding vehicle that prevents acceleration based on the target speed of the host vehicle is further present in the host lane, the lane change determination unit determines not to execute the lane change.

8. The lane change assistance device according to claim 3, wherein
in a case where the travel speed control is being executed and a speed difference between a current travel speed of the host vehicle and the target speed is equal to or greater than a threshold value, the lane change determination unit determines not to execute the lane change.

9. The lane change assistance device according to claim 3, further comprising:
a notification control unit configured to propose, when the travel speed control is being executed and the preceding vehicle is present in the host lane, the lane change to a driver of the host vehicle based on a speed difference between a current travel speed of the host vehicle and the target speed.

10. The lane change assistance device according to claim 1, wherein
when there is a lane change request from a driver of the host vehicle, the lane change determination unit determines whether the lane change is possible.

11. The lane change assistance device according to claim 10, wherein
the lane change request is a predetermined operation for a blinker lever of the host vehicle,
a position at which the blinker lever is movable includes
a neutral position,
a first position that is located in each of two directions different from each other with respect to the neutral position, and returns to the neutral position when the driver does not apply an operation force to the blinker lever, and
a second position that is located in each of two directions with respect to the neutral position, has an amount of movement from the neutral position greater than that of the first position, and is capable of being maintained when the driver does not apply an operation force to the blinker lever, and
the predetermined operation is an operation of maintaining the blinker lever at the first position.

12. The lane change assistance device according to claim 1, wherein
when the lane change is being executed and the inter-vehicle distance is equal to or less than a threshold value before the host vehicle reaches a division line configured to divide the host lane and the adjacent lane, the travel control unit stops the lane change.
